(19) United States
(12) Patent Application Publication
(10) Pub. No.: US 2015/0091299 A1
(43) Pub. Date: Apr. 2, 2015

(54) CONNECTOR TO REDUCE A FLUID VOLUME WHEN MATING WITH A COUNTERPART

(71) Applicant: General Electric Company, Schenectady, NY (US)

(72) Inventor: Jani Kauppi, Helsinki (FI)

(73) Assignee: General Electric Company, Schenectady, NY (US)

(21) Appl. No.: 14/038,998

(22) Filed: Sep. 27, 2013

(51) Int. Cl. F16L 37/244

(52) U.S. Cl. CPC F16L 37/244
USPC 285/332.2

(57) ABSTRACT

A connector to reduce a fluid volume when mating with a counterpart is disclosed. The connector includes a connector body having at least a conical body sector with a sealing surface configured to mate with the counterpart to seal this joint, and a recess inside the connector body and at least partly inside the conical body sector, the recess having a first opening and a second opening. The connector also includes a tube for a fluid flow, the tube extending through the second opening into the recess towards the first opening. The tube is configured to extend through the second opening at least to such a part of the recess, which is inside the conical body sector.

### BACKGROUND OF THE INVENTION

This disclosure relates generally to a connector to reduce a fluid volume when mating with a counterpart.

In anesthesia or in intensive care, the condition of a patient is often monitored e.g. by analyzing the air exhaled by the patient for its carbon dioxide content. For this reason, a small portion of the respiratory gas is delivered to a gas analyzer. The sample is carried along a sampling tube connected at one end of to a respiratory tube adapter and the other end to the gas analyzer. This sampling tube is typically disposable and must have some kind of reliable and tight but simple and cheap connectors. Almost all pneumatic connectors in the respiratory system have tapered conical contact surfaces. Such connectors are simple, easy to connect and cheap to make and they still provide an airtight and reliable connection. The connection such as a well-known fitting called Luer-Lok®, a registered trademark of Becton, Dickinson and Company of Franklin Lakes, N.J. USA, has been in general use for gas sampling but also other similar connectors with differing dimensions can be used. The tapered portion of the connector is nor conical with straight cross section sides because it gives a reliable and tight connection using a large contact area. The tapered portion could in principle also have curved cross section sides or one tapered connector in combination with a suitably designed semi-rigid counterpart. The contact surface responsible for the tightness is always on the tapered portion of the connector. Other possibilities would be cylindrical connectors with either axial or radial gaskets but they are more complicated and expensive and, consequently, not suitable as disposable components. Such connectors are typically used e.g. in pressurized gas lines or gas lines of more permanent nature.

The widely used connector for gas sampling is going to be banned from gas measurement applications in the near future. A new standardized connector is going to be introduced for gas applications. That connector is defined by ISO 80396. It is in principle similar to the widely used connector for gas sampling, but only bigger. The increased size has its flaws. Increased size has a negative effect on the rise time of the measurement and measurement accuracy. The increased size increases dead space inside the connection. Dead space increases mixing of the sampled gas and therefore increases the rise time of the measurement and makes it harder to use low sample flows and to monitor high respiratory rates.

An extra fluid volume such as a dead space is especially inherent in a tapered connection, which are commonly used in patient respiratory circuits. Such a respiratory circuit with a medical gas analyzer 11 is shown in FIG. 1. A patient 1 is connected to a ventilator 2 using an intubation tube 3, a Y-piece 4, an inspiratory limb 5 and an expiratory limb 6. In a respiratory circuit an airway adapter 7 for fluid sampling is usually included. All breathing tube connectors in this breathing circuit are typically conically tapered but the extra volume is critical especially for neonatal use. The reason for the extra volume problems with neonatal ventilation is that the tubing dimensions are designed for adult or pediatric use. Extra volume in a breathing circuit means that the gas exchange in the neonatal lungs is impaired because of inspiratory and expiratory gas mixing. Also the fluid sampling line 8 is connected using tapered connection fittings in the adapter end 9 and at the input 10 to the gas analyzer 11. These connectors are usually identical and could be conically tapered like well-known fluid connections on the market or otherwise tapered as described further on.

A gas analyzer designed to measure respiratory gas in real time has to be fast enough to resolve changes in the gas content. This is especially true for carbon dioxide, which varies from close to zero in the inspiratory phase to about 5% in the expiratory phase of the breathing cycle. It is then very important to streamline the complete gas sampling system. Many portions of the system with slowed down response can easily add up to unacceptable performance of the gas analyzer. The reason for an increased rise time of e.g. carbon dioxide is often an extra fluid volume, a dead space in the pneumatic line, where the gas flow is slowed down. The tapered conical connector is susceptible to such dead space, especially if the inner dimensions are significantly larger than those of the bore or sampling line itself. The inherent construction of the conical connector is such that dead space always is introduced and the amount is critically dependent on the tolerance of the conical dimensions. The connectors must allow for axial or longitudinal play in order to avoid the situation of touching axially because then air leak is likely to occur. Therefore, the tolerances always define an axial extra fluid volume in the connection to ensure tightness at the conical surfaces.

For a more or less stable gas composition the extra volume may not have any major impact on the measurement but for fast changes in gas composition the situation is different, especially when using a fast gas analyzer. This is shown in the graph of FIG. 4. The clashed line A represents the measurement of a typical gas concentration value rising quickly from about zero to a maximum relative value of 1 as a function of time in milliseconds. This could be a graph of the contribution from the tapered connection according to prior art to the response time of exhaled carbon dioxide from a patient as measured by the gas analyzer 11, rising from zero to about 5% of volume. The rise time is defined as the time between 10% and 90% of the maximum measured value, in this case 1. As can be seen, the curve reaches its final value very slowly, leaving it trail of previous gas, e.g. partly the inhaled gas, free of carbon dioxide. This trail often starts already before the signal has reached its 90% value with a considerable increase in the rise time value as consequence. The same applies to the fall time from the maximum of 1 to zero. The rise time of curve A is about 40 ms when it is supposed to be only about 10 ms. If the pneumatic system of the gas analyzer 11 otherwise is optimized this tail could reduce accuracy even beyond specification. Several similar connections in the sampling line would, of course, further worsen the situation. Needless to say, the same applies even more pronounced if the tapered connection would have larger dimensions than what was given above. Note that the curve only shows the contribution from a tapered connection, not the final breathing curve, the capnogram, of a patient. The short expiratory time period of about 100 ms is used only for illustrating purposes.

Minimal dead space is important also in gas or liquid chromatography. An attempt to make connections with capillaries is well-known. The female part of the connection is slightly tapered. in order to accept the cylindrical capillary tube and make a tight press-fit. This connector fitting is specially designed for conditions encountered in liquid or gas chromatography and is not intended for repeatedly made reliable connections like in gas analyzers. Robustness inevitably adds dead space to the bore of the connection.

In a neonatal application, the main ventilation circuit's extra fluid volume has to be as small as possible. There are different solutions to this problem. The connections are also conically tapered even if the dimensions are much larger than what would be used for a gas sampling system. In one solution, there is a sliding internal passage filling the dead space and in another solution a compressible member is used to exclude the extra fluid volume. However, especially for small and disposable connectors like those used in sampling lines of gas analyzers such moving or compressible features would be difficult to implement and would add to the expenses of a disposable accessory.

Since production volumes can be millions per year, the connector is usually made using injection molding. Because of the large volumes, the molds have often multiple cavities to increase productivity. More cavities mean usually also lower part costs. On the other hand, more cavities also complicate the production process making the process harder to control. In the case with conical connectors for example such as described above the important features include for example dimensional accuracy of the sealing surfaces, dimensional accuracy of the lock features, weld line control and sink mark control. There are many variables that are factors contributing in the good or bad end result. These parameters include for example material properties, mold construction, injection point, injection pressure, hold pressure and other known process parameters. All of the parameters can be used in process control, both in single cavity molds and in multi cavity molds. Part geometry and construction becomes more important in multi cavity molds. In other words, bad part construction can be more easily compensated with the process parameters in single cavity molds than in multi cavity molds.

Dimensional accuracy of the connector parts is required to produce leak free seals, to prevent going out of specifications and to minimize the dead space that has to exist at the bottom of the conical connection.

To preserve the integrity of the seal, the sealing surface must not have any significant sink marks, big weld lines or short shots. Therefore the surface thickness of the injection molded parts has to be small enough to avoid shrinkage when the molten material cools down inside the mold after injection but big enough to ensure good confidence of fill. Small shrinkage problems can be adjusted using the process parameters. Adjustment becomes harder to do when the mold cavity number increases and especially when the part geometry is not optimal. Wall thickness of the part has to be preferably uniform around the whole part or gradually shrinking towards fill direction. Therefore bulky features are not desired.

In FIG. 2 a prior art fluid connection is depicted. It consists of a female connector 12 with conically tapered inner surface 13 and a male connector 14 with a corresponding conically tapered outer surface 15. Additionally, there is a threaded attachment 16 to secure the connection. At least one end of the connection fitting is normally attached to the sampling line 8 with an inner diameter D1. The sampling line is inserted inside the connector but not as far as under the tapered surface. For gas sampling, the inner diameter D1 of the sampling line 8 is normally about 1 mm. Inside the male connector, under the conically tapered surface 15, the diameter is often widened to about D2=2.5 mm, obviously for manufacturing reasons. The widened area situates under the tapered surface 15 and opens towards the connector tip. This extra volume certainly adds to the extra volume of the connection but can easily be eliminated by reducing the diameter, such as shown in FIG. 3, or by extending the sampling line 8 closer to the connector tip which would result in the sampling line tip being unsupported inside the large dead space within the inner diameter D2.

According to the specifications of a well-known connector, the inner diameter D3 of the female connector, as shown in FIG. 2, at its bottom end is about 3.8 mm. Since the connectors cannot be allowed to touch axially a clearance and tolerance with length L1 is possible to calculate using the given tolerances of the 6% or about 3.4 degrees tapered portion. This length L1 can vary between a minimum of 1.0 mm and about 2.8 mm. It also defines the extra volume 17 such as an extra space inside the connection. Especially because of its inner diameter D3, which is almost four times the diameter D1 of the sampling line 8, the extra volume will have an influence on the response time of the gas analyzer 11. The reason for this is that part of the gas flow fills up this volume, which then functions as a reservoir for gas composition from a time period previous to the on-going flow time. Inner diameter D2 also defines an extra dead space extending volume 17 inside the male connector 14. To avoid bulky features the inner diameter D2 of the male connector 14 is relatively large around the outer surface 15, making the surface thickness even all around the part. The design has also steps/differences in diameter in the flow path that affects the measurements as described earlier.

One big contributor to the overall dead space is the extra volume 17 that is left on the bottom of the female connector 12. Due to the conical shape of the connectors the remaining dead space between the male and female connectors is strongly dependent on the size (tolerance) variations of the two parts. For example if the male connector outer diameter was bigger, it would not enter as deep inside the female as it would if the said diameter was smaller. When using standardized conical connectors the minimum distance between the tip of the male connector and the bottom of the female connector is defined by the standards. That feature prevents the connector from bottoming and thus remaining loose and leaking. However, the standard allows significant variations in the insertion depth of the connectors and therefore also in dead space. Tolerances are a result of normal process variation in injection molding and with good part design they can be more easily controlled. With good part design the tolerance variance can be more easily minimized and it can also be directed to a suitable side of tolerance spectrum.

The other big contributor is the dead space inside the male connector. Unlike the dead space between the connectors this is not defined by the standard. When using for example injection molding. which is the most common manufacturing method, the limitations come from the manufacturing process-, quality-, productivity- and price requirements. Some of them are described above.

Another known method to injection mold a conical connector is to increase the wall thickness of the conical part reducing inner diameter D2 inside the conical surface as shown in FIG. 3. In an optimal situation D2 is the same as the inner diameter D1 of the sampling line 8. This method produces parts that will provide a faster and more accurate measurement. The problem with this design is manufacturing it in large volumes using injection molding while still haying an effective and robust process. The reason is that the design has significant variations in surface thickness and bulky features. around the conical part area. Both resulting in increased difficulty in injection molding, sink mark control and overall harder design to implement especially in a multi cavity mold and further resulting in the problems described above such as leakage, dimension control and dead space. The problems increase when the external size of the conical connector increases and the internal flow channel stays small, in which case the wall thickness increases. This happens for example between the well-known connector for gas sampling and the ISO 80396 connector. The flow channel cannot increase in diameter because of the rise time and accuracy requirements.

### BRIEF SUMMARY OF THE INVENTION

The above-mentioned shortcomings, disadvantages and problems are addressed herein which will be understood by reading and understanding the following specification.

In an embodiment a connector to reduce a fluid volume when mating with a counterpart includes a connector body having at least a conical body sector with a sealing surface configured to mate with the counterpart to seal this joint, and a recess inside the connector body and at least partly inside the conical body sector, the recess having a first opening and a second opening. The connector to reduce a fluid volume when mating with a counterpart also includes a tube for a fluid flow, the tube extending through the second opening into the recess towards the first opening. The tube is configured to extend through the second opening at least to such a part of the recess, which is inside the conical body sector.

In another embodiment a connector to reduce a fluid volume when mating with a counterpart includes a connector body having at least a conical body sector with a sealing surface configured to mate with the counterpart to seal this joint, and a recess inside the connector body and at least partly inside the conical body sector, the recess having a first opening and a second opening. The connector to reduce a fluid volume when mating with a counterpart also includes a tube for a fluid flow, the tube extending through the second opening into the recess towards the first opening. The tube is configured to extend through the second opening at least two thirds of a whole length of the recess inside the conical body sector.

In yet another embodiment a connector to reduce a fluid volume when mating with a counterpart includes a connector body having at least a conical body sector with a sealing surface configured to mate with the counterpart to seal this joint, and a recess inside the connector body and at least partly inside the conical body sector, the recess having a first opening and a second opening. The connector to reduce a fluid volume when mating with a counterpart also includes a tube for a fluid flow, the tube extending through the second opening into the recess towards the first opening. The tube is configured to end at a distance from the first opening, which is less than two times an inner diameter of the tube or, more specifically, less than 1.5 times an inner diameter of the tube, or, even more specifically less than one time an inner diameter of the tube.

Various other features, objects and advantages of the disclosure will be made apparent to those skilled in the art from the accompanying drawings and detailed description thereof.

### BRIEF DESCRIPTION OF THE SEVERAL VIEWS OF THE DRAWINGS

FIG. 1 illustrates a schematic perspective view of a typical monitoring situation with intubated subject and with various fluid connections;

FIG. 2 illustrates as prior art a conically tapered fluid connection;

FIG. 3 illustrates as prior art a conically tapered fluid male connector;

FIG. 4 shows in a graph how an extra fluid volume of the fluid connection contributes to the response time of a gas concentration measurement;

FIG. 5 shows one embodiment of a conically tapered fluid connector to reduce a fluid volume;

FIG. 6 shows the conically tapered fluid connector of FIG. 5 when the connector body and the tube are detached from each other;

FIG. 7 shows one embodiment of a fluid connection when the fluid connector of FIG. 5 is connected to a counterpart;

FIG. 8 shows another embodiment of a conically tapered fluid connector without a tube;

FIG. 9 shows the conically tapered fluid connector of FIG. 8 with the tube;

FIG. 10 shows another embodiment of a conically tapered fluid connector without a tube;

FIG. 11 shows the conically tapered fluid connector of FIG. 10 with the tube;

FIG. 12 shows another embodiment of a conically tapered fluid connector with a tube; and

FIG. 13 shows a front view of the fluid connector of FIG. 11.

### DETAILED DESCRIPTION OF THE INVENTION

Specific embodiments are explained in the following detailed description making a reference to accompanying drawings. These detailed embodiments can naturally be modified and should not limit the scope of the invention as set forth in the claims.

A connector for mating with a counterpart to avoid extra fluid volume, such as a dead space, is described. The fluid flow, such as gas flow, can be guided through this connector. With the design explained hereinafter, it would be easier to avoid dead space for example in the ISO 80369 connection bore or any conical/tapered connector facing similar problems advantageously without the drawbacks of the large external size.

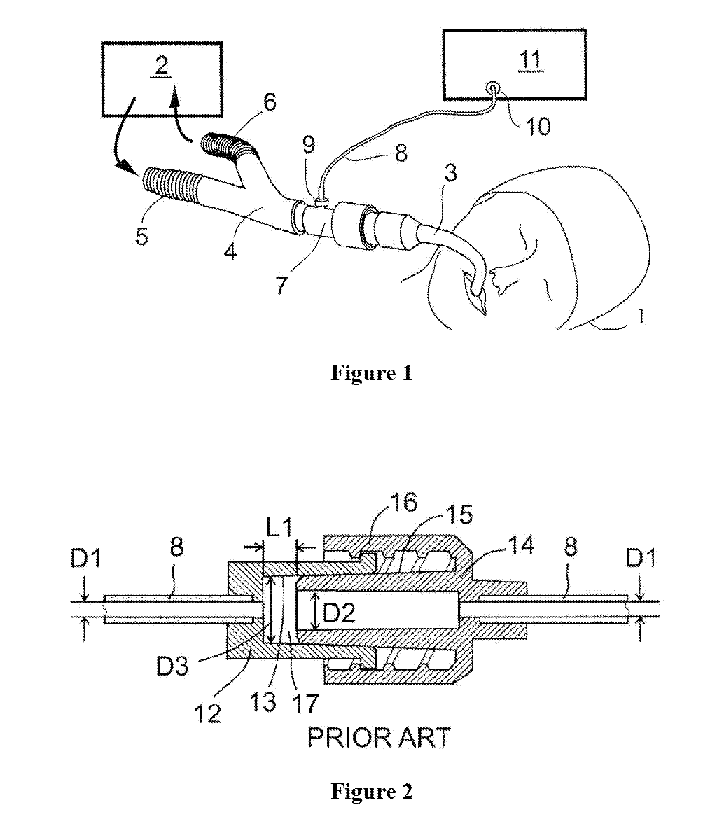

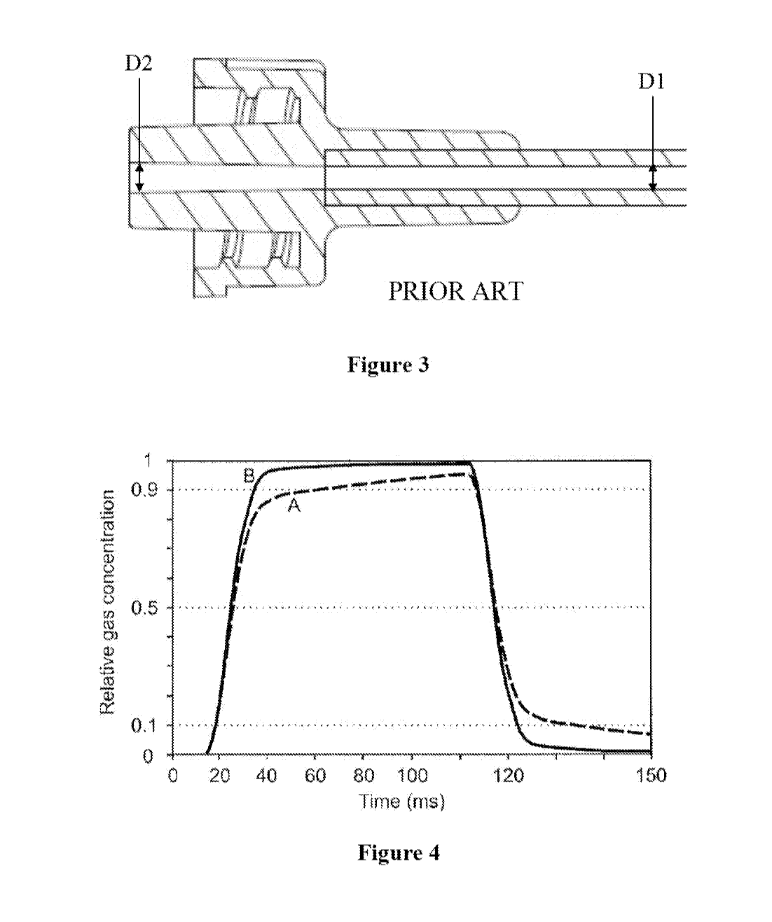

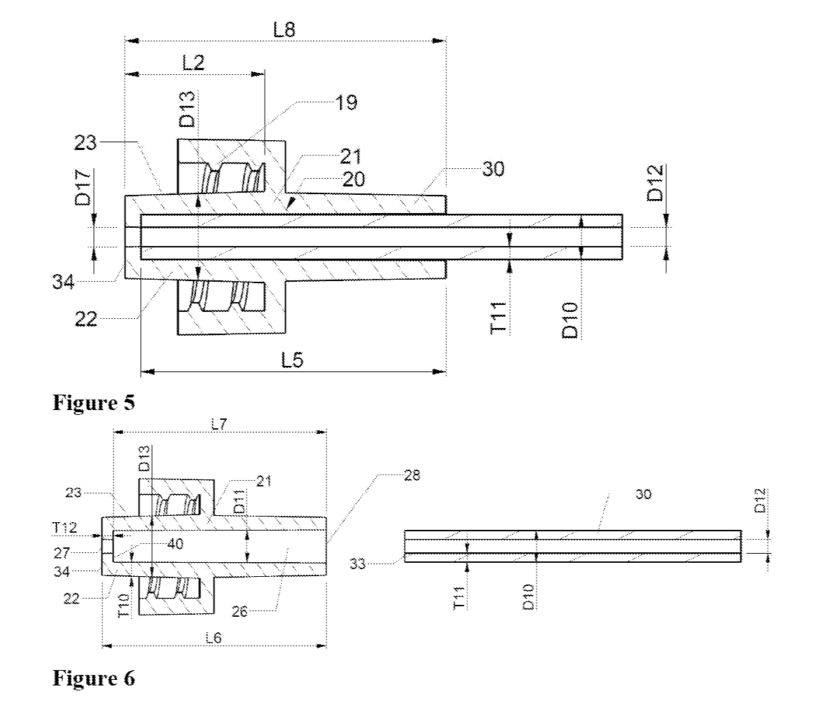

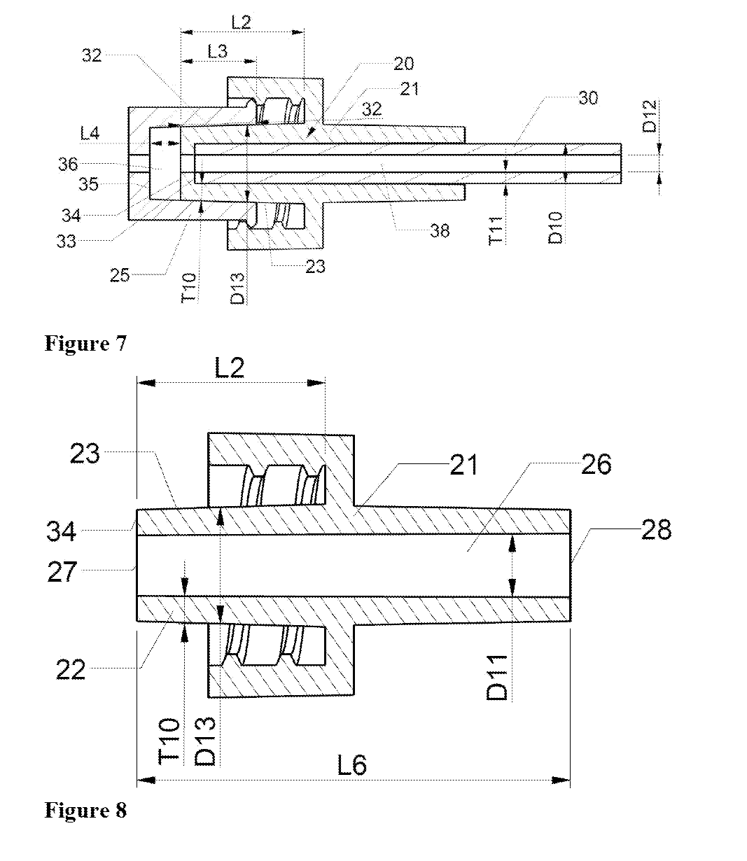

One embodiment is shown in FIGS. 5 and 6, which show a connector 20, such as a male connector, comprising a connector body 21 with a length L6 having a conical body sector 22. This connector can be implemented for example into an environment shown in FIG. 1. This sector having a length L2 is provided with a sealing surface 23 mating with a counterpart 25, such as a female connector, as shown in FIG. 7 to make a sealed joint. The connector also comprises a recess 26 inside the connector body 21. This recess having a length L8, which length may be same in some embodiments as a length L6 of the connector body 21, is at least partly inside the conical body sector 22, but typically the recess may extend through a whole length L2 of the conical body sector. The recess is provided with a first opening 27 and a second opening 28 extending between these openings as shown especially in FIG. 6. The first opening and second opening of the recess may be on opposite ends of the connector body. The connector 20 further comprises a tube 30 to guide the fluid flow, the tube extending through the second opening into the recess and towards the first opening 27. Also there may be a threaded attachment 19 to secure the connection. This threaded attachment is not always present because a tapered connection easily remains in position and airtight by fiction of its surfaces.

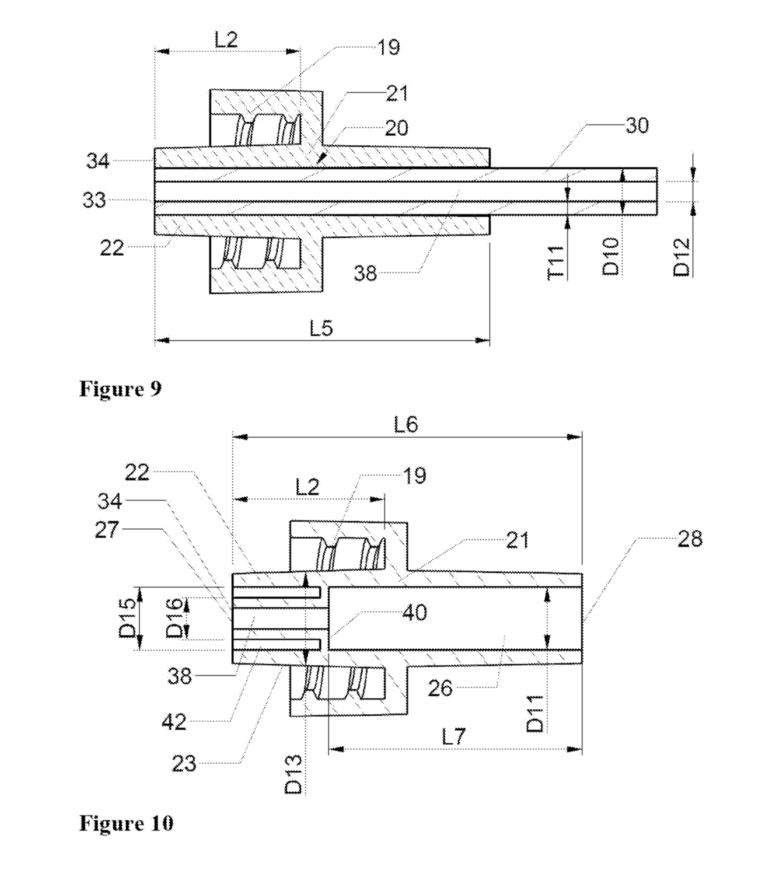

The connector may have a threshold 40 in the recess to prevent the tube extending through the first opening 27. The threshold is situated around the L2 area and at least partly inside the conical body sector 22. Threshold 40 marks a change in the recess 26 diameter. The advantage of this approach is that for example the tube 30 can be assembled against the threshold, in which case an inner diameter D17 of the recess at least partly surrounded by the threshold 40 is less than the inner diameter D11 of the recess for the tube between the second opening 28 and the threshold 40. The threshold may be closer to the first opening 27 than the second opening 28. typically around the recess at the first opening, the threshold may make the assembly easier. The length L7 between the second opening 28 and the threshold 40 can vary to some extent depending on the threshold 40 placement. The recess inner diameter D11 along length L7 may be designed to receive the tube 30, but it can also differ from an outer diameter D10 of the tube 30 to some extent. These are explained in more detail later. Typically an inner diameter of the recess inside the conical body sector is at least as large as the outer diameter D10 of the tube. The threshold 40 is not always present because the recess can be made without the threshold as shown in FIGS. 8 and 9. There might also be more than one threshold inside the recess 26. Threshold 40 can be a feature situated inside the recess 26. This means that the diameter of the recess 26 can change between the threshold 40 and the tip of the connector 34 as well as on the other side, between the threshold 40 and the second opening 28. It should he noted that diameters may he understood as dimension values, too.

FIG. 6 shows the connector body 21 and the tube 30 disassembled. In accordance with an embodiment the recess 26 inside the connector body 21 may be positioned under the sealing surface 23. That can be done by utilizing a mold core that makes a recess 26 for the tube 30. In other words the same recess 26 can be used for tube attachment and for making the injection molding of the connector body 21 easier. By positioning the recess 26 inside the conical body sector 22, which part of the sector is surrounded by the sealing surface 23, the same recess can be used both to manage a wall thickness T10 of the conical body sector 22 of the injection molded part between the sealing surface 23 and the recess 26, which is around the areas where sealing requirements are high, and to attach the tube 30. The sealing requirements are highest around a sealing area 32 of the conical body sector 22 having a length L3 along a longitudinal axis of the recess 26. The sealing area 32 covers at least such part of the sealing surface 23 which is mating with the counterpart when connected. The wall thickness T10 can be adapted to help manage and fine tune the injection molding process by modifying the dimensions of an outer diameter D10 of the tube 30 in relation to the size of the inner diameter D11 of the recess 26. This adjustment can be done without adding any extra to a volume 36 which would be the case in prior art design. Diameters D10 and D11 are dimensioned to fit together during assembly. By changing the diameters, it is possible to fine time the wall thickness T10 of the conical body sector 22 by modifying a wall thickness T11 of the tube 30. This can be done without having to modify the inner diameter D12 of the tube 30. This helps to achieve fluster rise times. The inner diameter D11 of the recess 26. receiving at least the tip 33 of the tube 30 inside at least part of the conical body sector 22 having a length L2, or alternatively inside at least part of the sealing area 32 having a length L3 may be less than 10% bigger than the outer diameter D 10 of the tube 30, or, more specifically less than 5% bigger than the outer diameter D 10 of the tube 30, or, even more specifically less than 2% bigger than the outer diameter D 10 of the tube 30. The inner diameter D11 of the recess 26 receiving the tip 33 of the tube 30 could even be slightly smaller than the outer diameter D 10 of the tube 30 to make possibly tight sealing with the tube 30. Thus the tube 30 may be in tight contact, typically even fluid tight contact, with the connector body 21 inside the conical body sector 22, advantageously also inside the sealing area 32. It would be advantageous if the tube 30 around the tip 33 is in tight contact with the conical body sector to minimize the volume 36 and thus the dead space.

FIG. 7 represents the connector 20, such as a male connector, together with the counterpart 25, such as a female connector. A distance L4 may cause the volume 36 between a tip 34 of the connector 20 and an opposite end 35 of the counterpart 25. The volume 36, such as a dead space, also correlates with the assembled length L3 of the sealing area 32 between the connector 20 and the counterpart 25. The volume correlates with connector diameters. The diameters correlate with the wall thickness and the ease of manufacturing and the ability to achieve dimensional accuracy.

The ability to fine tune the wall thickness 110 of the conical body sector 22 without the drawback of adding to the volume such as a dead space results in better dimension and quality control of the sealing surface 23 and therefore resulting in better process accuracy and easier process control to reach better dimensional accuracy from part to part and from batch to batch. Smaller sealing surface diameter D13 is one desired goal that can be achieved in a more constant way with the explained design. That again increases the average insertion depth of the connector 20 corresponding to the sealing area 32 and that results in less volume 36. which is a dead space, between the connector 20 and the counterpart 25. This can be done without breaking the tolerance limits of a standard connector or of a custom conical connector or without bottoming into the opposite end of the counterpart, which would cause leaks.

Rapid changes in the wall thickness T10 of the conical body sector 22, for example step-like changes or gradual changes, are not desired, but the design could still work even with the changes in the wall thickness 110 present in the design. Changes that are less than 10% of the wall thickness T10 or around 10% of the wall thickness T10 might not have a severe impact on quality. These might be for example changes in the recess draft angle or slight chamfers on the recess surface. Changes around 25% of the wall thickness T10 might already cause some problems especially in multi cavity molds. Changes around 50% of the wall thickness T10 of the conical body sector 22 might cause severe problems for example if the changes occur around the length L3 of the sealing area 32 along a longitudinal axis of the recess 26 or especially the sealing area 32. Rapid or gradual changes in the inner diameter D11 of the recess 26 occurring outside of the sealing area 32 would cause less problems in injection molding, but might still have some negative effect on the tube to the connector interface depending on other parameters. In other words, the connection between the parts might be compromised. This is if the change causes large material clusters. If the rapid changes do not cause large material clusters the change might not have significant impact on quality. A good example of this is the thickness of intersecting wall having the thickness T12, that for example creates the threshold 40. It is a wall that is intersecting with the conical body sector 22 with the wall thickness T10. A general rule is that intersecting wall, whose thickness in this case is T12, can be 0.5 times the thickness of the wall, in this case conical body sector 22, in order to have a sink mark free surface on the wall. So, if T12 is less than 0.5 times T10, there are no major problems in sealing surface 23 quality around the intersection area. If T12 is more than 0.5 times T10, there might be problems with sealing surface 23 quality around the intersection area. Quality problems on surface 23 increase when T12 increases in relation with T10. Problem area is usually situated around the intersection area, so they should especially be avoided around the sealing area 32. The same applies if a similar step or steps or intersecting wall or -walls are situated anywhere else around the conical body sector area 22 inside the recess 26. Step height is less critical than the distance of the area having a changed diameter along the longitudinal axis of the recess 26.

This embodiment hereinbefore also reduces dramatically the volume 36 found in some of the prior art designs caused by diameter D2 inside the conical surface and the whole conical. connection between the connector 20 and the counterpart 25 by helping to minimize the length between the tip 34 of the connector 20 and the opposite end 35 of the counterpart 25 and therefore volume 36. This can be done without the drawbacks of the prior art designs. In the preferred designs it removes the dead space inside the connector 20 totally. In order to get full benefits out of the design the tube 30 is assembled into the recess 26, filling this recess inside the connector 20 and making the fluid flow path. 38 through the whole connector free of any cavities that would cause dead spaces. The tube 30 can be attached for example by gluing or by using solvent to melt the parts together and to seal the connection. Using glue helps to fill cavities that might be between the mated parts because of design or dimensions. Using solvent helps to equalize slight overlapping differences in diameters.

The tube 30 may extend through the second opening 28 of the connector 20 into the recess 26, which means that tube depth L5 can vary to some extent. There is no need to use the whole conical body sector 22 for sealing i.e. the length L3 of the sealing area 32 along the axis of the recess 26 is usually less than the length L2 of the conical body sector 22, such as the conical surface length, along the axis of the recess 26. Therefore the tube may extend through the second opening 28 of the recess 26 to at least such part of the recess which is inside the conical body sector. The tube may extend at least one third of the whole length of the recess inside the conical body sector 22. It is even better if the tube can extend into the recess at least half of the whole length of the recess inside the conical body sector or at least two thirds of the whole length of the recess inside the conical body sector. Better results can be achieved if the tube may extend through the second opening at least to such part of the recess which is besides inside the conical body sector 22 but also inside the sector where the sealing area 32 will mate with the counterpart 25 to make a sealed joint. Typically tube is configured to extend through the second opening 28 and through the recess 26 inside the conical body sector 22 towards the first opening 27 ending at a distance from the first opening, which is less than two times an inner diameter of the tube or, more specifically, 1,5 times an inner diameter of the tube, or, even more specifically less than one time an inner diameter of the tube. The tube may also extend through the second opening all the way through the recess 26 inside the conical body sector 22 to the first opening 27, which may be at a tip 34 of the connector 20.

As explained hereinbefore, it is advantageous to have the tube 30 close to the tip 34 of the connector, for example at a distance of around 0.5 mm-1 mm from the tip depending on the connector size. Or alternatively at a distance of similar scale as the wall thickness T10 of the conical body sector 22. This approach helps the assembly, as the tube can be pressed against the threshold 40 of the recess 26, if such threshold exist, but naturally the recess can be without the threshold in which case the tube may extend to the tip 34 of the connector. However, the thickness T12 of the intersecting wall, which creates for example the threshold 40, can be also anything between 0 mm and 0.5 mm. This results in less bulky features around the sealing area 32 and results therefore into longer length L3 of the sealing area that is free of sink marks. The threshold 40 can also be anywhere in the recess 26. inside the sealing area 32 or better two thirds of the length L3 of the sealing area from the tip 34 of the connector or still better one third of the length L3 of the sealing area away from the tip 34 of the connector or even better less than one third away from the tip 34 of the connector. The more sealing area 32 there is intact, the better seal there is. If the recess 26 goes through the whole connector 20 without the threshold 40, the tube 30 can be positioned for example by an assembly jig.

These embodiments discussed hereinbefore having less bulky features help also the injection molding, especially when trying to reach dimensional accuracy and the sealing surface diameter D13 that is as close to the minimum tolerance of the diameter. The sink marks caused by the bulky features or intersecting walls can be compensated using a large hold pressure. That may result in slightly increased part dimensions, for example the sealing surface diameter D13, resulting in the increased volume 36 described above. Because of the conical sealing surfaces 23, even really small. dimensional changes result in large differences in insertion depth and thus the length of L3 of the sealing area 32. The embodiments also help to control the leakage caused by sink marks around the tip 34 of the connector 20 or connector body 21.

The sampling line can be assembled into the bottom surface 40 of the recess 26 which is a good option, but it can be also assembled at an offset from the bottom surface 40, resulting in an additional dead space inside the connector 20. However, both alternatives would remove or reduce respectively all the problems from the steps or changes in diameter in the flow path 38 that are necessary in the prior art as shown in FIG. 2. If the offset is close to zero it should not affect the measurement very much. If it is close to the length L2 of the conical body sector 22 it may have a similar effect as the prior art design. If it is in between the two, the end result should be better than the prior art.

The recess 26—along length L7 having the inner diameter D11 that is designed to receive the tube 30, may also go through the whole connector 20 as explained hereinbefore and as shown in FIGS. 8 and 9. FIG. 8 shows the connector 20 without the tube 30 and FIG. 9 shows connector 20 assembled with the tube 30. The tube 30 is positioned at the tip 34 of the connector 20 in accordance with an advantageous embodiment in FIG. 9 or inside the recess 26 with slight offset from the tip 34 of the connector 20. The latter approach would result in a small additional dead space inside the connector. However, both alternatives would remove or reduce respectively all the problems from the steps or changes in diameter in the flow path 38 that are necessary in the prior art. If the offset is close to zero it should not affect the measurement very much. If it is close to the length L2 of the conical body sector 22 it will have a similar effect as the prior art design. If it is in between the two, the end result should be better than the prior art.

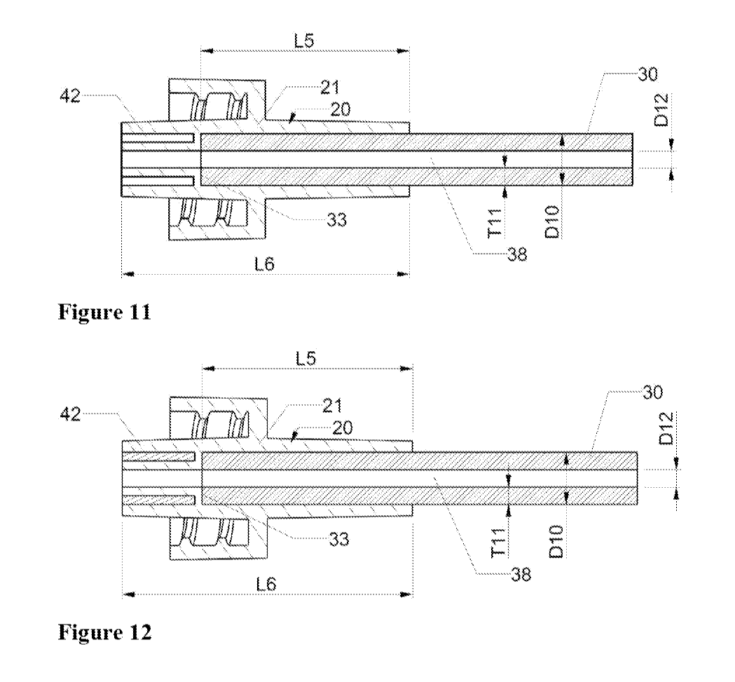

If the recess 26 along length L7 having diameter D11 that is designed to receive the tube 30, is not situated inside the sealing area 32, it may not help to improve the injection molding, therefore causing the problems described above. The same situation can occur if the length L7 of the recess between the threshold 40 and the second opening 28 is not entirely extending into the sealing area 32. In these cases at least one hollow 42 at the tip 34 of connector 20 around the recess 26 or between the recess and the sealing surface 23 as shown in FIGS. 10, 11 is advantageous. The at least one hollow 40 may extend along the longitudinal axis of the recess 26 inside the conical body sector 22 from the tip 34 of the connector. This is an alternative method of avoiding the shrinkage issue on the sealing surface 23 on the conical body sector 22 for the distance area of the length L6 of the connector body along the longitudinal axis of the recess 26 minus the recess 26 along length L7 having diameter D11 that is designed to receive the tube 30 while haying a small inner diameter D12 of the tube 30 and the flow path 38. It can be done for example by having a 2-shot injection molded part that has the hollow 42 in the connector body 21 in a first shot as shown in FIG. 10 and FIG. 11, which hollow 42 is then filled in the second phase of 2-shot injection molding with the second shot as shown in FIG. 12.

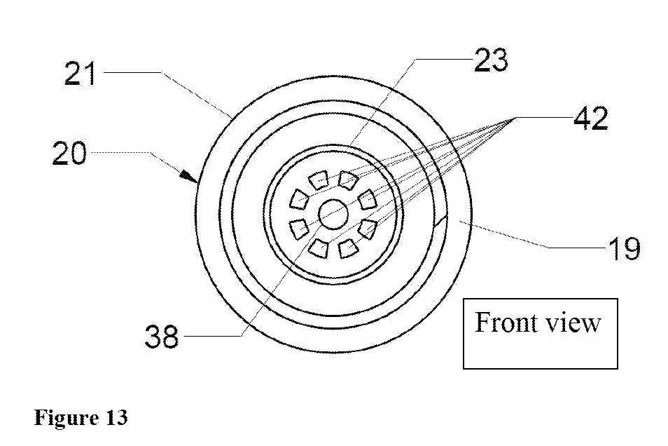

In a cylindrical injection molded connector an advantageous option would be to have a cylindrical hollow shape around the flow path 38, which hollow may be for example apart from the recess 26. The smaller inner diameter D16 of the hollow 42 has to be big enough to leave a tubular channel for the sampled gas to flow through. In the preferred option this feature can have the same diameter as the inner diameter D12 of the tube 30. The size of the hollow 42 and the recess 26 can be used to adjust the surface thickness of the first shot in areas around the flow path 38 between the first opening 27 and the second opening 28 of the connector 20, both along distance L7 and around the hollow 42. It results in the same benefits described above. Maximum outer diameter D15 of the hollow 42 may be less than the conical sealing surface diameter D13. The assembly steps are shown in FIG. 10, FIG. 11 and FIG. 12. FIG. 10 shows the connector body 21 without the tube 30. The steps can also be done in alternative order. FIG. 11 shows the connector body 21 attached together with the tube 30. FIG. 12 shows the final assembly. The hollow 42 can also be a combination of multiple different smaller hollows 42 arranged in a cylindrical formation around the central axis of the connector and thus around the recess 26 or the flow path 38 as shown in FIG. 13.

The filler material for at least one hollow 42 can be the same as the first shot or it can be other material as well. It can be injection molded, transfer molded or tilled using a separate method, for example gluing. There is no need to use the whole sealing surface 23 along the length L2 of the conical body sector 22 for sealing. Therefore the minimum depth of the hollow 42 has to be within the range of the sealing area 32 of the connector pair. The maximum depth of the hollow 42 is less than the length L2 of the conical body sector 22, i.e. the hollow 42 plus the recess 26 along length L7 having diameter D11, that is designed to receive the tube 30, is max. the length L6 of the conical body 21.

An alternative method of avoiding the shrinkage issue on the sealing surface 23 while having a small inner diameter D12 of the tube 30 is to have a similar hollow 42 that FIG. 11 represents. This design is in principle similar than in FIG. 12 but without the second shot or gluing that fills the hollow 42. The advantage of this approach compared to the previous is the price. The downside is that the rise time and accuracy of the measurement might not work equally well in both directions, for example in a tube where the same connector type would be at both ends of the line. The unfilled hollow 42 would be an extra dead space.

The embodiments of this application help to develop a connector that is relatively large in scale for easy handling and good mechanical strength, but still having a small enough flow path 38 and the volume 36 to ensure fast and accurate measurement. The connector is also easy to produce with accurate dimensions in large production volumes.

The written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A connector to reduce a fluid volume when mating with a counterpart, the connector comprising:
a connector body having at least a conical body sector with a sealing surface configured to mate with the counterpart to seal this joint;
a recess inside the connector body and at least partly inside the conical body sector, the recess having a first opening and a second opening; and
a tube for a fluid flow, the tube extending through the second opening into the recess towards the first opening;
wherein the tube is configured to extend through the second opening at least to such a part of the recess, which is inside the conical body sector.

2. The connector according to claim 1, wherein the tube is configured to extend through the second opening at least to one third of the whole length of the recess inside the conical body sector.

3. The connector according to claim 1, wherein the tube is configured to extend through the second opening at least half of the whole length of the recess inside the conical body sector.

4. The connector according to claim 1, wherein the tube is configured to extend through the second opening at least two thirds of the whole length of the recess inside the conical body sector.

5. The connector according to claim 1, wherein the tube is configured to extend through the second opening at least to such a part of the recess which is besides inside the conical body sector but also inside a sector where the sealing surface is configured to mate with the counterpart for a sealed joint.

6. The connector according to claim 1, wherein the tube is configured to extend through the second opening and through the recess inside the conical body sector towards the first opening ending at a distance of 0.5 mm-1 mm from the first opening at a tip of the connector.

7. The connector according to claim 1, wherein the tube is configured to extend through the second opening and through the recess inside the conical body sector towards the first opening ending at a distance from the first opening, which is less than two times an inner diameter of the tube or, more specifically, less than 1.5 times an inner diameter of the tube, or, even more specifically less than one time an inner diameter of the tube.

8. The connector according to claim 1, wherein the tube is configured to extend through the second opening all the way through the recess inside the conical body sector to the first opening.

9. The connector according to claim 1, wherein the connector is a male connector.

10. The connector according to claim 1, wherein an inner diameter of the recess inside conical body sector is at least as large as an outer diameter of the tube.

11. The connector according to claim 1, wherein the first opening and second opening of the recess are on opposite ends of the connector body.

12. The connector according to claim 1, wherein the tube having a tip is configured to be in tight contact at least around the tip with the conical body sector.

13. The connector according to claim 1, wherein the tube is configured to be in tight contact with the conical body sector.

14. The connector according to claim 1, wherein the connector also comprising at least one hollow around the first opening of the recess, but apart from the recess to avoid a shrinkage issue on the sealing surface.

15. The connector according to claim 1, wherein the connector also comprising at least one hollow around the first opening of the recess, the at least one hollow being between the recess and the sealing surface extending along a longitudinal axis of the recess inside the conical body sector.

16. The connector according to claim 15, wherein the hollow is configured to be tilled with a suitable material.

17. The connector according to claim 1, further comprising a threshold in the recess configured to prevent the tube extending through the first opening.

18. The connector according to claim 17, wherein the recess is configured to have an inner diameter for the tube and the recess surrounded by the threshold is configured to have an inner diameter, which is less than the inner diameter for the tube.

19. A connector to reduce a fluid volume when mating with a counterpart, the connector comprising:
a connector body having at least a conical body sector with a sealing surface configured to mate with the counterpart to seal this joint;
a recess inside the connector body and at least partly inside the conical body sector, the recess having a first opening and a second opening; and
a tube for a fluid flow, the tube extending through the second opening into the recess towards the first opening;
wherein the tube is configured to extend through the second opening at least two thirds of a whole length of the recess inside the conical body sector.

20. A connector to reduce a fluid volume when mating with a counterpart, the connector comprising:
a connector body having at least a conical body sector with a sealing surface configured to mate with the counterpart to seal this joint;
a recess inside the connector body and at least partly inside the conical body sector, the recess having a first opening and a second opening; and
a tube for a fluid flow, the tube extending through the second opening into the recess towards the first opening;
wherein the tube is configured to end at a distance from the first opening, which is less than two times an inner diameter of the tube or, more specifically, less than 1.5 times an inner diameter of the tube, or, even more specifically less than one time an inner diameter of the tube.
